(19) United States
(12) Patent Application Publication
(10) Pub. No.: US 2025/0134083 A1
(43) Pub. Date: May 1, 2025

(54) INSECT COLLECTION SYSTEM WITH AIRFLOW CONTROL AND INSECT PROTECTION

(71) Applicant: San Joaquin County Mosquito & Vector Control Dist., Stockton, CA (US)

(72) Inventor: Shaoming Huang, Dublin, CA (US)

(21) Appl. No.: 18/386,222

(22) Filed: Nov. 1, 2023

(51) Int. Cl. A01M 1/08

(52) U.S. Cl. CPC A01M 1/08

(57) ABSTRACT

An insect collection system comprises a collection unit configured to collect an insect, an airflow generator configured to create airflow through the collection unit, and a power source configured to power the airflow generator. The insect trapping system is configured so that the airflow travels through the collection unit before traveling through the airflow generator. The collection unit comprises an input opening configured to allow air and the insect to enter the collection unit and an output opening. The output opening is configured to allow air to exit the collection unit while preventing the insect from exiting the collection unit. The insect collection system also includes an airflow modifier configured to modify how air flows through the collection unit, thereby creating a first airflow rate in a first portion of the collection unit and a second airflow rate in a second portion of the collection unit.

### TECHNICAL FIELD

The present invention generally relates to systems and methods for insect collection. More specifically, the present invention relates to insect collection with variable airflow control and insect protection.

### BACKGROUND INFORMATION

The art and science of collecting insects have long fascinated entomologists, biologists, and hobbyists alike. Over the years, the tools employed for this purpose have undergone significant transformations, echoing the broader journey of human innovation. From the rudimentary to the refined, each era of insect collection has its hallmark devices, each with its strengths and drawbacks.

In the nascent stages of insect collection, the primary tool of choice was the hand-held net. A simple and intuitive instrument, it consisted of a lightweight netting material stretched over a frame. Its beauty lay in its portability and directness, enthusiasts could directly chase and capture flying insects such as butterflies and dragonflies. However, its range was restricted to the arm's length of the user, and it proved inefficient for capturing minuscule or terrestrial insects.

As understanding of insect behavior grew, it became evident that insects were profoundly influenced by pheromones. This realization birthed the pheromone trap-a device that uses insect-specific pheromones as bait. While these traps boasted specificity, the pheromones had to be periodically replenished, and not all insects of a given species might be attracted.

In the contemporary era, the convergence of biology and technology has given birth to automated insect collection systems. Marrying principles of airflow, electronic control, and barriers, these devices epitomize efficiency. However, they come with their own set of challenges, including cost, maintenance, energy dependency, and most of all insect harm.

In conclusion, the field of insect collection mirrors the broader human story of progress. Each device, from the humble net to the sophisticated automated system, embodies the knowledge and aspirations of its time. As we march forward, armed with deeper insights into insect behavior and equipped with advancing technology, the horizon of insect collection promises even more specialized and efficient tools.

### SUMMARY

An insect collection system (abbreviated to ICS hereafter), having a collection unit configured to collect an insect, an airflow generator configured to create airflow through the collection unit, and a power source configured to power the airflow generator. The ICS is suspended on a structure, having a height suitable for attracting the intended insect species. For its intended use, the power source is activated to power the airflow generator, creating an airflow from an input opening to an output opening. Insects in the surrounding environment are pulled towards the ICS and deposited into a collection unit, having a filter that allows the passage of air out of the ICS while preventing insects from exiting the collection unit.

Therefore, a general object of the invention is to capture live insects in an area from the environment and contain them without harm. One possible use is to capture insects alive for sampling of various viruses. Whether for use by hobbyists, researchers, or otherwise, the various embodiments of the ICS provide enhanced utility to capture, maintain, and transport collected insects.

Many preexisting insect collection systems utilize exposed fans that may incur harm to the insect. An embodiment of the ICS presented uses an airflow generator that has been covered over by mesh to trap insects. A downward airflow, modified to be faster from an input opening through an airflow modifier, presents a barrier to insects attempting to escape through the input opening. A collection unit seal is utilized to seal the collection unit when the power source is turned off. The collection unit may be separated from a housing unit and a mounting system for further transportation of captured insects.

Certain insects are attracted to certain wavelengths of light. A light source, such as a bulb, radiating at a desired wavelength may be affixed proximal to the input opening and connected to the power source to initially attract insects within suction range of the ICS.

Certain insects are attracted to the presence of certain chemicals in the air. A container for chemical bait may be included, proximal to the input opening, to initially attract insects. For example, dry ice (frozen CO₂) may be loaded into the compartment to attract mosquitos.

A control system comprising a processing unit and corresponding sensors may be coupled with the ICS for further data collection.

In a first novel aspect, an insect collection system includes a collection unit configured to collect an insect, an airflow generator configured to create airflow through the collection unit, and a power source configured to power the airflow generator. The insect trapping system is configured so that the airflow travels through the collection unit before traveling through the airflow generator.

In a second novel aspect, the collection unit includes an input opening configured to allow air and the insect to enter the collection unit. The collection unit also includes an output opening that is configured to allow air to exit the collection unit while preventing the insect from exiting the collection unit.

In a third novel aspect, the output opening of the collection unit includes a mesh. The mesh comprises openings large enough to allow air to flow through the mesh and exit the collection unit. At the same time the mesh openings are small enough to prevent the insect from traversing the mesh and exiting the collection unit.

In a fourth novel aspect, the airflow generator is a fan, a vacuum system, or a convection system.

In a fifth novel aspect, the airflow generator includes an electric motor, a plurality of ball bearings, and a fan blade.

In a sixth novel aspect, the power source is one or more batteries configured to output an electric current to the electric motor.

In a seventh novel aspect, the system further includes an airflow modifier configured to modify how air flows through the collection unit.

In an eighth novel aspect, the airflow modifier is a funnel, a flap, a contour, or a cavity.

In a ninth novel aspect, the system further includes a housing configured to attach the collection unit, the airflow generator, and the power source together.

In a tenth novel aspect, the collection unit is configured to generate a reflected light having a wavelength of approximately six-hundred and twenty (620) nanometers to seven-hundred and fifty (750) nanometers.

In an eleventh novel aspect, the housing is configured to attached to a mounting system.

In a twelfth novel aspect, the mounting system is a hanger, a clamp, a strap, a bracket, an adhesive, or a stand.

In a thirteenth novel aspect, the system is configured so that the insect does not pass through the airflow generator.

In a fourteenth novel aspect, the airflow modifier increases a first rate of airflow in a first interior portion of the collection unit, and the airflow modifier decreases a second rate of airflow in a second interior portion of the collection unit.

In a fifteenth novel aspect, the system further includes a switch configured to control a connection between the power source and the airflow generator.

In a sixteenth novel aspect, the system further includes a processor circuit and a memory circuit. The processor circuit is configured to execute one or more instructions stored in the memory circuit, and the one or more instructions cause the processor circuit to control the operation of the insect collection system.

In a seventeenth novel aspect, the system includes a communication circuit configured to communicate data between the insect collection unit and a computing device. The communication circuit is a wireless communication circuit or a wired communication circuit.

In an eighteenth novel aspect, the system includes a collection unit, an airflow generator, a means for preventing an insect from passing through the airflow generator,
a means for generating a first air flow rate in a first portion of the collection unit, and a means for generating a second air flow rate in a second portion of the collection unit. The insect collection system is configured such that generated airflow travels through the collection unit before passing through the airflow generator.

In a nineteenth novel aspect, the means for preventing an insect from passing through the airflow generator is a filter.

In a twentieth novel aspect, the means for generating the first air flow rate in a first portion of the collection unit and the means for generating a second air flow rate in a second portion of the collection unit is an airflow modifier.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a first diagram of the insect collection system in its intended use, according to an embodiment of the present invention.

FIG. 2 is a second diagram of the insect collection system in an assembled state, according to an embodiment of the present invention.

FIG. 3 is a third diagram of the insect collection system in an exploded view, according to an embodiment of the present invention.

FIG. 4 is a fourth diagram of the insect collection system, focusing on the airflow changes when passing through the airflow modifier, according to an embodiment of the present invention.

FIG. 5 is a fifth diagram of the insect collection system, focusing on the change of airflow as the airflow proceeds through an airflow modifier into a collection unit, according to an embodiment of the present invention.

FIG. 6 is a first flowchart describing the operation of the insect collection system, according to an embodiment of the present invention.

FIG. 7 is a second flowchart describing the operation of the insect collection system, in more detail and according to the embodiment presented in FIG. 5.

FIG. 8 is a sixth diagram of the insect collection system, describing an overview of the processor system, according to an embodiment of the present invention.

### DETAILED DESCRIPTION

Reference will now be made in detail to background examples and some embodiments of the invention, examples of which are illustrated in the accompanying drawings. In the description and claims below, relational terms such as “top”, “down”, “upper”, “lower”, “top”, “bottom”, “left” and “right” may be used to describe relative orientations between different parts of a structure being described, and it is to be understood that the overall structure being described can actually be oriented in any way in three-dimensional space.

The Insect Collection System (ICS) comprises several embodiments of a system configured for use in collection of insects. Each of the embodiments of the ICS described herein comprises at least a collection unit and an airflow generator. The design allows for an enhanced method to collect insects. In some embodiments, the ICS enhances the utility in attracting, collecting, and transporting insects without incurring harm to said insects. As explained in more detail below, the basic embodiment of the ICS may be combined with other elements and/or modified to include other features that increase utility.

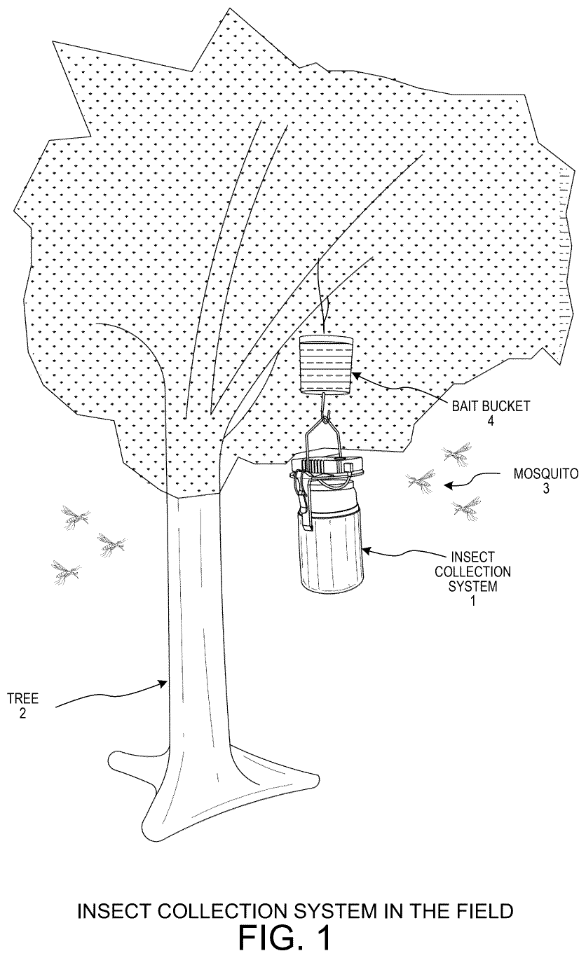

As described in FIG. 1, an ICS 1 is suspended from an object 2 to attract insects 3. The object 2 may be any structure that allows for a suitable height to position the ICS 1 to attract airborne insects. In one example, object 2 is a tree. In the current embodiment, insects 3 are mosquitoes, but may be any desired species of insect.

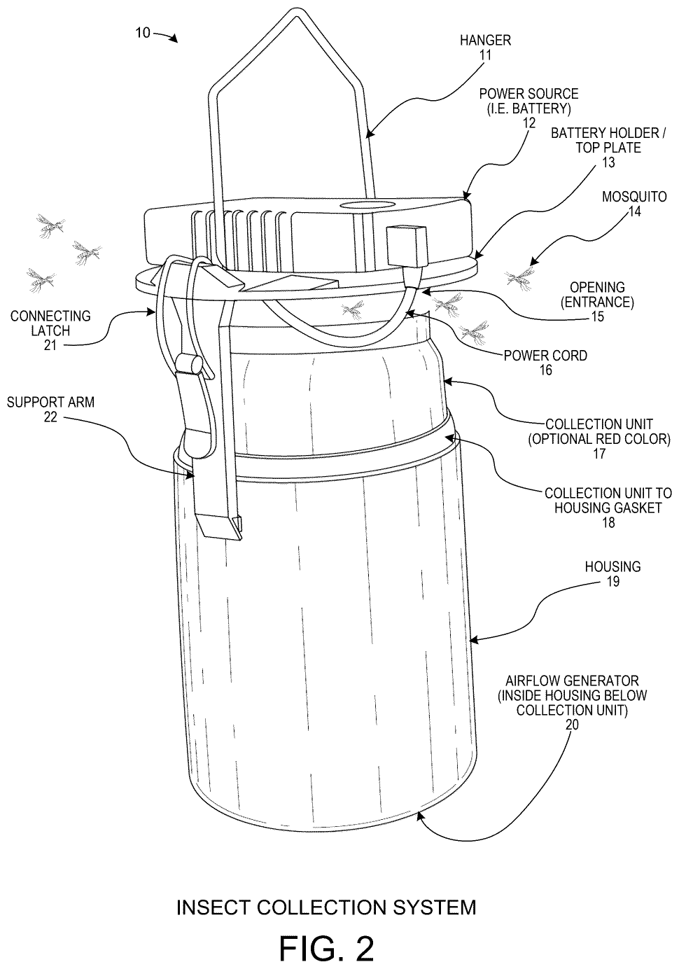

As described in FIG. 2, an ICS 10 is assembled and shown having a mounting system 11. A power source 12 is mounted on the device, to power the airflow generator 20. A switch is paired with the power source 12 to control a connection between the power source and the airflow generator 20. A wired connection 16 interfaces between power source 12 and airflow generator 20 to provide power. Mounting system 11 and power source 12 are paired to a top plate 13. An input opening 15 allows airflow and insects 14 to enter a collection unit 17, via an airflow modifier. A gasket 18 couples the collection unit 17 to housing 19. Top plate 13 is attached to a housing 19 via a latching mechanism 21. Latching mechanism 21 is coupled to support arm 22. Support arm 22 is attached to housing 19.

Further described in FIG. 2, mounting system 11 may be a hanger, a clamp, a strap, a bracket, an adhesive, or a stand. Power source 12 may comprise one or more batteries configured to output an electric current to the electric motor in airflow generator 20. In one example, power source 12 includes a lithium-ion battery. The wired connection 16 may be a USB cable. Wired connection 16 may pass through small tunnels located within support arm 22 to power airflow generator 20. The wired connection 16 may also be connected to a light source. In one example, the light source is located near the ICS entrance so to attract desired insects to enter the ICS. The frequency of the light source may be configured to attract a desired type of insect. The airflow modifier (not shown) may be a funnel, a flap, a contour, or a cavity. The airflow modifier increases a first rate of airflow at the entrance of ICS located around the perimeter of the ICS, and wherein the airflow modifier decreases a second rate of airflow in an interior portion of the collection unit 17. Collection unit 17 is configured to collect insects. Airflow generator 20 may be a fan, a vacuum system, or a convection system. Airflow generator 20 comprises an electric motor, ball bearings, and a fan blade.

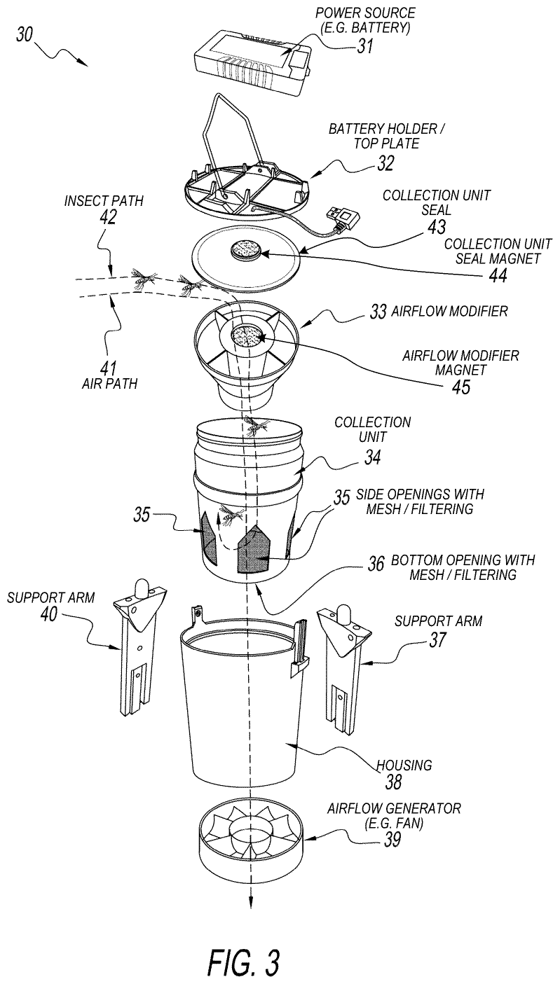

FIG. 3 is an exploded view of an insect collection system (ICS) 30. The ICS 30 comprises a power source 31 mounted on a top plate 32. An airflow modifier 33 provides an input opening and is coupled to a collection unit 34 having an output opening comprised of side mesh 35 and bottom mesh 36. Airflow modifier 33 and collection unit 34 are configured to be optionally covered by collection unit seal 43 to prevent collected insects from escaping the collection unit 34. In one embodiment, airflow modifier 33 comprises an airflow modifier magnet 45, and collection unit seal 43 comprises a collection unit seal magnet 44. The two magnets are configured to attract each other such that the collection unit seal 43 properly mates and maintains a seal to the top opening of the collection unit 34 and airflow modifier 33.

The collection unit 34 is selectively coupled to a housing 38. The top plate 32 is coupled to the housing 38 via support arms 37, 40. An airflow generator 39 is attached to the bottom of housing 38. Top plate 32 may further comprise a light source. In one example, the light source is located on the inferior side of the top plate 32. Side mesh 35 and bottom mesh 36 are configured to allow air to exit the collection unit 34 while preventing insects from exiting the collection unit 34. Support arms 37, 40, may comprise a plurality of support arms that couple the top plate 32 and housing 38.

Air modifier 33 provides two benefits. First, air modifier 33 concentrates the high speed air flow toward the ICS entrance (the perimeter of the air flow modifier 33 input). Second, air modifier 33 concentrates the high speed air flow toward the center portion of collection unit 34.

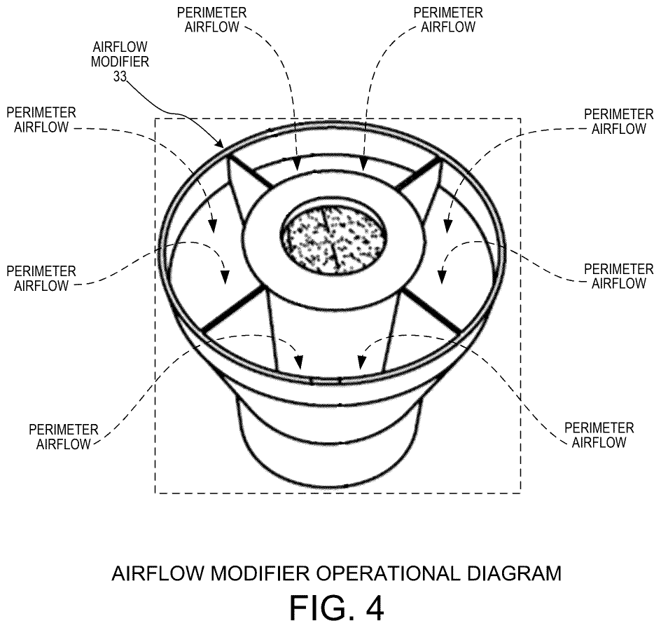

The first benefit of air modifier 33 is illustrated in FIG. 4. The top (entry) side of the air modifier 33 has openings along the outer perimeter and a blocked portion at the center area. This configuration allows for air flow to enter into the airflow modifier along the outer perimeter of the air modifier input, while blocking air flow at the center portion of the airflow modifier input. This configuration results in accelerated air flow along the perimeter of the airflow modifier which is the location of the ICS entrance. This modification of air flow provides improved insect collection performance by causing a high air suction flow at the ICS entrance where desired insects arrive.

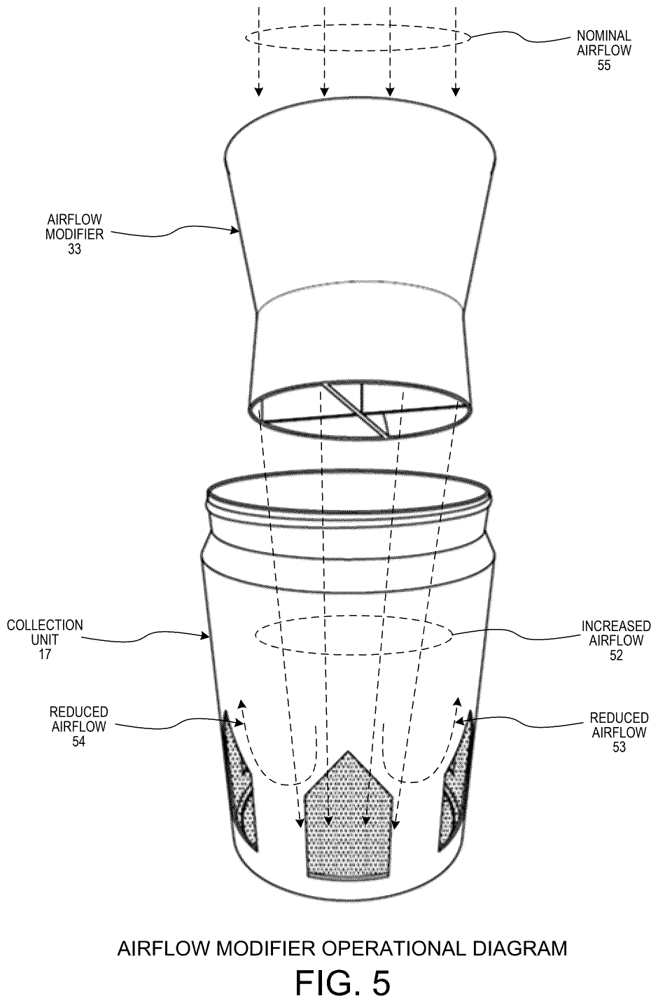

The second benefit of air modifier 33 is illustrated in FIG. 5. As illustrated in FIG. 5, the airflow modifier 33 is configured to funnel the nominal airflow 55, thereby outputting the air flow in a volume narrower than the collection unit 17 width (increased airflow 52). This funneling of the airflow causes two rates of airflow to be created within the collection unit 17. The first rate of airflow toward the center of the collection unit 17 has a faster rate of airflow due to the funnel operation (increased airflow 52). The second rate of airflow toward the outer edge of the collection unit 17 has a slower rate of airflow due to the funnel operation (reduced airflow 54, 53). The creation of a second rate of airflow in a second portion of the collection unit 17 is beneficial, in that the collected insects naturally congregate in the outer edge of the collection unit 17 where the rate of airflow is reduced. Insects in slower airflow rate environments tend to suffer fewer injuries and have a high probability of survival compared to those in higher airflow rate environments.

With regard to the previous FIGS. 1-5, further embodiments of the components of the ICS are described.

Power sources 12, 31 may comprise a lithium-ion battery, nickel-cadmium battery, or other suitable type.

A light source may be affixed to top plate 13, 32 to attract insects with an affinity towards certain wavelengths of the radiated light. In an embodiment configured for mosquito collection, a housing 19, 38 is configured to generate a reflected light having a wavelength of approximately 620 nanometers to 750 nanometers. This corresponds to the color red. A collection unit 17, 34 may also be configured to generate a reflected light having a wavelength of approximately 620 nanometers to 750 nanometers.

Airflow generator 20, 39 may be a fan, a vacuum system, or a convection system. Airflow generator 20, 39 may have an airflow volume rate of approximately 50 to 150 cfm (cubic feet per minute).

In order to prevent collected insects from escaping the ICS, a collection unit seal 43 is configured to optionally block the ICS entrance. In one embodiment, the collection unit seal 43 interfaces with airflow modifier 33. Collection unit seal 43 may include a first magnet 44 located at its center. Conversely, air flow modifier 33 may include a second magnet 45 located at its center and configured to attract the first magnet 44 of the collection unit seal 43. In this fashion, the attraction between the first 44 and second 45 magnets lock the collection unit seal 43 in position blocking the upper opening of air flow modifier 33 and collection unit 17. In another example, the collection unit seal 43 may contain means for fastening to the airflow modifier 17, 33 comprising a screw top, latch, or any other attachment mechanism known to one skilled in the art.

In operation, air flow generator 39 is enabled thereby creating air flow traveling through the ICS along air path 41 illustrated in FIG. 5. The light source located proximate to the ICS entrance is illuminated to attract desired insects, such as mosquitos. The air flow traveling through the ICS is concentrated to the ICS entrance (the perimeter of the collection unit) by air flow modifier 33. The concentrated air flow creates increased air suction at the ICS entrance. When an insect flies in proximity to the ICS entrance, the insect is pulled into the ICS entrance and then into the collection unit 34. Once in collection unit 34, the collected insect is blocked from traveling along air path 41 toward air flow generator 39 by a mesh or filter included in the collection unit 34. This air filtering provides two benefits. First, the collected insect is prevented from passing through the air flow generator 39 that can harm or kill the collected insect (making the insect less useful for purposes requiring undamaged or alive insects). Second, the air filtering prevents the collected insect from escaping the collection unit 34, thereby preserving the insect for latter collection and testing. Once the collection process is completed, the collection unit seal 43 may be put into place, thereby sealing the collection unit 34 and preventing any collected insects from escaping the collection unit 34. Once the collection unit seal 43 is put into place, the air flow generator 39 may be disabled and the collection unit 34 may be removed from the ICS and used to transport the collected insects to a desired location.

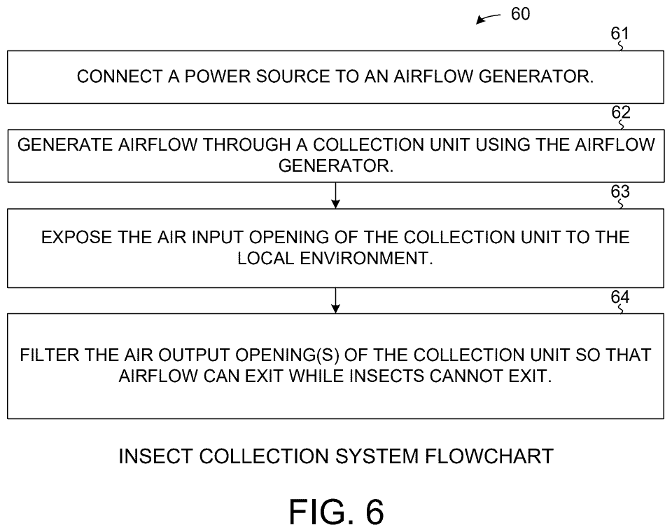

As described in FIG. 6, the ICS 60 is operated by first connecting a power source to an airflow generator (step 61). Second, airflow is generated through a collection unit using the airflow generator (step 62). The air input opening of the collection unit is exposed to the local environment (step 63). The air output opening(s) of the collection unit are filtered so that airflow can exit while insects cannot exit (step 64).

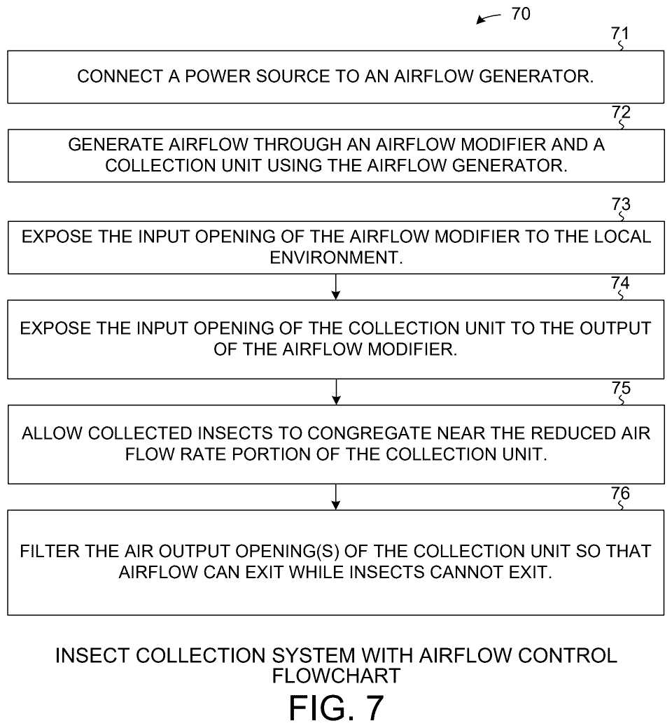

As described in FIG. 7, the ICS 70 is operated by first connecting a power source to an airflow generator (step 71). An airflow is then generated through an airflow modifier and a collection unit using the airflow generator (step 72). The input opening of the airflow modifier is exposed to the local environment (step 73). The input opening of the collection unit is then exposed to the output of the airflow modifier (step 74). Next, insects intended for collection are allowed to congregate near the reduced air flow rate portion of the collection unit (step 75). Next, the air output opening(s) of the collection unit are filtered so that airflow can exit while insects cannot exit (step 76).

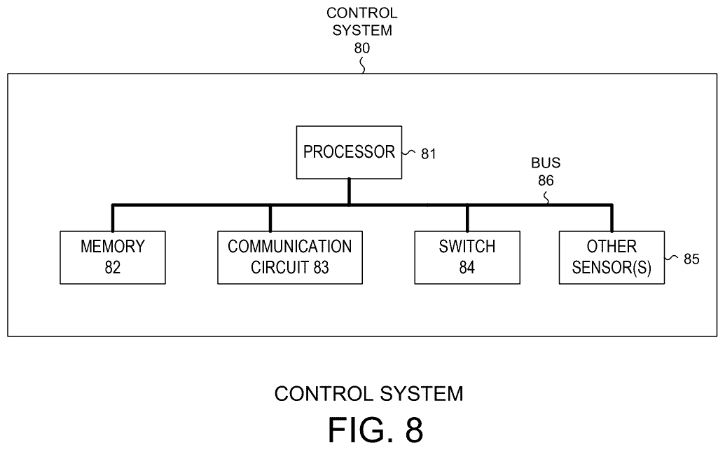

As described in FIG. 8, the ICS comprises a control system 80, further comprising a processor 81, a memory 82, a communication circuit 83, a switch 84, other sensors 85, and a bus 86.

Processor 81 is a circuit configured to execute one or more instructions stored in memory 82, which is also a circuit. The one or more instructions cause the processor circuit 81 to control the operation of the ICS. A communication circuit 83 is configured to communicate the data between the ICS and a computing device. The communication circuit may be a wireless or wired communication circuit.

In one example, the control system may be operable to remotely enable or disable the ICS. In another example, the control system may be operable to send data relevant to the number, type or status of insect collected by the ICS. In yet another example, the control system may be operable to send status information regarding the operation of the ICS to a network location or network device.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. An insect collection system, comprising:
a collection unit configured to collect an insect;
an airflow generator configured to create airflow through the collection unit; and
a power source configured to power the airflow generator, wherein the insect trapping system is configured so that the airflow travels through the collection unit before traveling through the airflow generator.

2. The insect collection system of claim 1, wherein the collection unit comprises:
an input opening configured to allow air and the insect to enter the collection unit;
an output opening, wherein the output opening is configured to allow air to exit the collection unit, and wherein the output opening is configured to not allow the insect to exit the collection unit.

3. The insect collection system of claim 1, wherein the output opening of the collection unit comprises:
a mesh, wherein the mesh comprises openings large enough to allow air to flow through the mesh and exit the collection unit, and wherein the mesh openings are small enough to prevent the insect from traversing the mesh and exiting the collection unit.

4. The insect collection system of claim 1, wherein the airflow generator is a fan, a vacuum system, or a convection system.

5. The insect collection system of claim 1, wherein the airflow generator comprises:
an electric motor;
ball bearings; and
a fan blade.

6. The insect collection system of claim 5, wherein the power source is one or more batteries configured to output an electric current to the electric motor.

7. The insect collection system of claim 1, further comprising:
an airflow modifier configured to modify how the airflow flows through the collection unit.

8. The insect collection system of claim 7, wherein the airflow modifier is a funnel, a flap, a contour, or a cavity.

9. The insect collection system of claim 1, further comprising:
a housing configured to attach the collection unit, the airflow generator, and the power source together; and
a light source, wherein the light source is located proximate to an entrance to the insect collection system, and wherein the light source is attached to the insect collection system.

10. The insect collection system of claim 9, wherein the collection unit is configured to generate a reflected light having a wavelength of approximately six-hundred and twenty (620) nanometers to seven-hundred and fifty (750) nanometers.

11. The insect collection system of claim 9, wherein the housing is configured to attach to a mounting system.

12. The insect collection system of claim 11, wherein the mounting system is a hanger, a clamp, a strap, a bracket, an adhesive, or a stand.

13. The insect collection system of claim 1, wherein the insect collection system is configured so that the insect does not pass through the airflow generator.

14. The insect collection system of claim 1, wherein the airflow modifier causes a first rate of airflow in a first interior portion of the collection unit, and wherein the airflow modifier causes a second rate of airflow in a second interior portion of the collection unit.

15. The insect collection system of claim 1, further comprising:
a switch configured to control a connection between the power source and the airflow generator.

16. The insect collection system of claim 1, further comprising:
a processor circuit; and
a memory circuit, wherein the processor circuit is configured to execute one or more instructions stored in the memory circuit, and wherein the one or more instructions cause the processor circuit to control the operation of the insect collection system.

17. The insect collection system of claim 16, further comprising:
a communication circuit configured to communicate data between the insect collection unit and a computing device, wherein the communication circuit is a wireless communication circuit or a wired communication circuit.

18. An insect collection system, comprising:
a collection unit;
an airflow generator, wherein the insect collection system is configured such that generated airflow travels through the collection unit before passing through the airflow generator;
a means for preventing an insect from passing through the airflow generator,
a means for generating a first air flow rate in a first portion of the collection unit; and
a means for generating a second air flow rate in a second portion of the collection unit.

19. The insect collection system of claim 18, wherein the means for preventing an insect from passing through the airflow generator is a filter.

20. The insect collection system of claim 18, wherein the means for generating the first air flow rate in a first portion of the collection unit and the means for generating a second air flow rate in a second portion of the collection unit is an airflow modifier.
